(19) United States
(12) Patent Application Publication
(10) Pub. No.: US 2009/0053593 A1
(43) Pub. Date: Feb. 26, 2009

(54) BATTERY

(75) Inventors: Takeru Yamamoto, Fukushima (JP); Tomoyuki Nakamura, Fukushima (JP); Yuji Uchida, Fukushima (JP); Saori Tokuoka, Fukushima (JP); Takahiro Endo, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/816,833

(22) PCT Filed: Feb. 14, 2006
(86) PCT No.: PCT/JP2006/302491

§ 371 Date: Aug. 22, 2007

(30) Foreign Application Priority Data
Feb. 24, 2005 (JP) 2005-048612

(51) Int. Cl. H01M 2/06

(52) U.S. Cl. 429/163

(57) ABSTRACT

A battery capable of suppressing the swollenness and improving the capacity and the like is provided. The battery includes a spirally wound electrode body (20) in which a cathode and an anode are layered with a separator and an electrolyte in between and spirally wound inside a package member (30) made of an aluminum laminated film. The cathode or the anode contains, as an absorber, a graphite material in which an average face distance d002 of (002) planes of a hexagonal crystal obtained by X-ray diffraction method is from 0.3354 nm to 0.3370 nm, and a peak belonging to a (101) plane of a rhombohedral crystal can be obtained by the X-ray diffraction method. Thereby, gas can be absorbed and thus swollenness can be suppressed. In addition, the battery characteristics such as the capacity can be improved.

### TECHNICAL FIELD

The present invention relates to a battery that includes a cathode, an anode, and an electrolyte inside a film package member.

### BACKGROUND ART

In recent years, many portable electronic devices such as a combination camera (Videotape Recorder), a mobile phone, and a notebook personal computer have been introduced, and downsizing and weight saving of such devices have been made. Accordingly, as a portable power source for such electronic devices, development of batteries, in particular the secondary batteries have been actively promoted. Specially, lithium ion secondary batteries have attracted attentions as batteries capable of realizing the high energy density.

Meanwhile, in the lithium ion secondary battery, the voltage is high, the oxidation potential of the cathode is extremely noble, and the reduction potential of the anode is extremely poor. Therefore, there has been a disadvantage that as a side reaction other than battery reaction, a nonaqueous solvent used for the electrolytic solution is decomposed, and thus gas is generated. Further, when moisture is mixed therein, reaction with lithium is caused to generate hydrofluoric acid, and thus the side reaction might be generated as well. Therefore, from the past, it has been considered that regardless of primary batteries or secondary batteries, a carbon material having the high specific area as a gas absorber is inserted in the battery (for example, refer to Patent documents 1 and 2). Further, it has been also considered that though not as the gas absorber, a mixture of a plurality of carbon materials is used in the batteries (for example, refer to Patent documents 3 to 7).

Patent document 1: Japanese Patent Publication No. 3067080
Patent document 2: Japanese Unexamined Patent Application Publication No. 8-24637
Patent document 3: Japanese Patent Publication No. 3216661
Patent document 4: Japanese Unexamined Patent Application Publication No. 6-111818
Patent document 5: Japanese Unexamined Patent Application Publication No. 2001-196095
Patent document 6: Japanese Unexamined Patent Application Publication No. 2002-8655
Patent document 7: Japanese Unexamined Patent Application Publication No. 2004-87437

### DISCLOSURE OF THE INVENTION

However, as the performance of the battery has been improved in these years, it has been aspired that swollenness of the battery is further suppressed as well. Further, there has been another disadvantage that when an activated carbon known as a gas absorber so far is inserted into the battery, a side reaction is generated in the battery, and thus the battery characteristics such as the capacity are lowered.

In view of the foregoing, it is an object of the invention to provide a battery capable of further suppressing the swollenness and improving the battery characteristics such as the capacity.

A battery according to the invention includes a cathode, an anode, an electrolyte, and a film package member containing the cathode, the anode and the electrolyte therein. At least one of the cathode and the anode contains a graphite material in which an average face distance d002 of (002) planes of a hexagonal crystal obtained by X-ray diffraction method is from 0.3354 nm to 0.3370 nm, and a peak belonging to a (101) plane of a rhombohedral crystal can be obtained by the X-ray diffraction method.

Since the battery according to the invention contains the foregoing graphite material, impurity such as moisture and gas generated by side reaction can be absorbed and thus swollenness can be suppressed. In addition, the battery characteristics such as the capacity can be improved.

### BRIEF DESCRIPTION OF THE DRAWINGS

FIG. 1 is an exploded perspective view showing a structure of a secondary battery according to an embodiment of the invention; and

FIG. 2 is a cross section taken along line II-II of a spirally wound electrode body shown in FIG. 1.

### BEST MODE FOR CARRYING OUT THE INVENTION

An embodiment of the invention will be hereinafter described in detail with reference to the drawings.

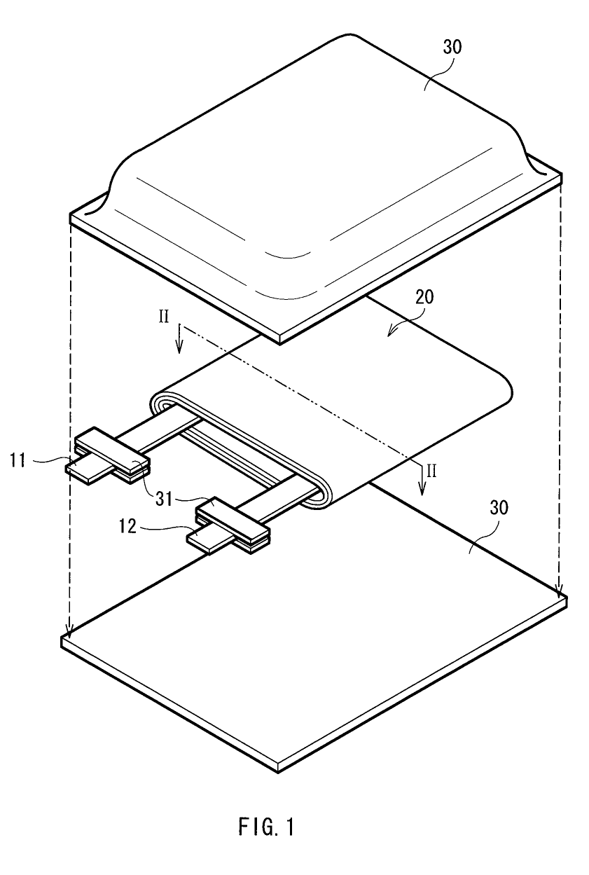

FIG. 1 shows a structure of a secondary battery according to an embodiment of the invention. In the secondary battery, lithium is used as an electrode reactant. The secondary battery includes a spirally wound electrode body 20 to which a cathode terminal 11 and an anode terminal 12 are attached inside a film package member 30.

The cathode terminal 11 and the anode terminal 12 are respectively directed from inside to outside of the package member 30 in the same direction, for example. The cathode terminal 11 and the anode terminal 12 are respectively made of, for example, a metal material such as aluminum, copper (Cu), nickel (Ni), and stainless, and are in the shape of a thin plate or mesh.

The package member 30 is made of a rectangular aluminum laminated film in which, for example, a nylon film, an aluminum foil, and a polyethylene film are bonded together in this order. The package member 30 is, for example, arranged so that the polyethylene film side faces the spirally wound electrode body 20, and the respective outer edges are contacted to each other by fusion bonding or an adhesive. Adhesive films 31 to protect from entering of outside air are inserted between the package member 30 and the cathode terminal 11, the anode terminal 12. The adhesive film 31 is made of a material having contact characteristics to the cathode terminal 11 and the anode terminal 12, for example, is made of a polyolefin resin such as polyethylene, polypropylene, modified polyethylene, and modified polypropylene.

The package member 30 may be made of other aluminum laminated film in which an aluminum foil is sandwiched between other polymer films. In addition, the package member 30 may be made of a laminated film having other structure, a polymer film such as polypropylene, or a metal film.

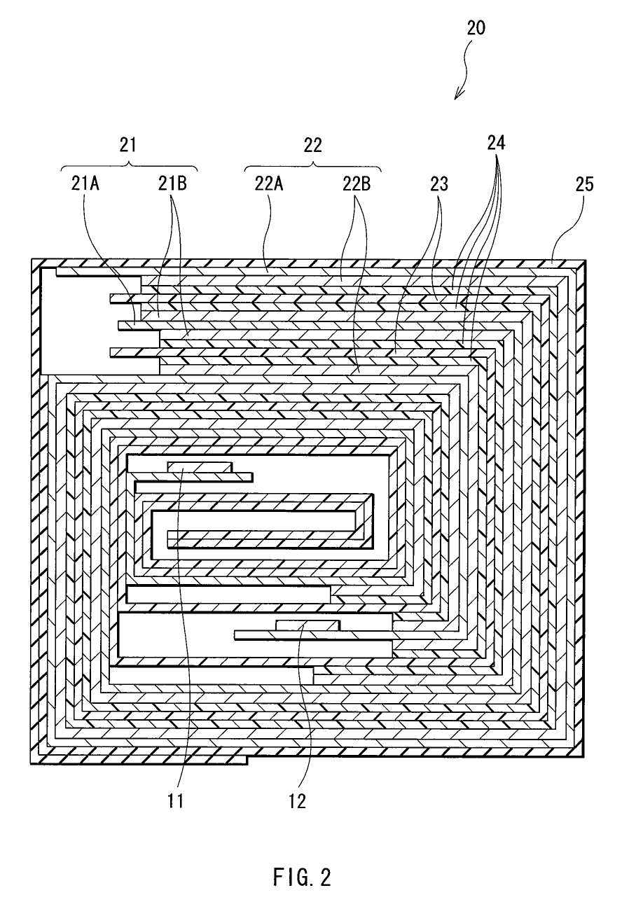

FIG. 2 shows a cross sectional structure taken along line II-II of the spirally wound electrode body 20 shown in FIG. 1. In the spirally wound electrode body 20, a cathode 21 and an anode 22 are layered with a separator 23 and an electrolyte 24 in between and spirally wound. The outermost periphery of the spirally wound electrode body 20 is protected by a protective tape 25.

The cathode 21 has a cathode current collector 21A having a pair of opposed faces and a cathode active material layer 21B provided on the both faces of the cathode current collector 21A. In the cathode current collector 21A, there is an exposed portion provided with no cathode active material layer 21B on one end thereof in the longitudinal direction. The cathode terminal 11 is attached to the exposed portion. The cathode current collector 21A is made of a metal foil such as an aluminum foil, a nickel foil, and a stainless foil. The cathode active material layer 21B contains, for example, as a cathode active material, one or more cathode materials capable of inserting and extracting lithium. If necessary, the cathode active material layer 21B may contain an electrical conductor and a binder.

As the cathode material capable of inserting and extracting lithium, for example, a chalcogenide containing no lithium such as titanium sulfide (TiS₂), molybdenum sulfide (MoS₂), niobium selenide (NbSe₂), and vanadium oxide (V₂O₅); a lithium complex oxide or a lithium-containing phosphate compound that contains lithium; or a polymer compound such as polyacetylene and polypyrrole can be cited.

Specially, lithium complex oxides containing lithium and a transition metal element, or lithium-containing phosphate compounds containing lithium and a transition metal element are preferably used, since thereby a high voltage and a high energy density can be obtained. In particular, a compound containing at least one of cobalt (Co), nickel, manganese (Mn), and iron (Fe) as a transition metal element is preferable. The chemical formula thereof is expressed by, for example, LiₓMIO₂ or Li_{y}MIIPO₄. In the formula, MI and MII represent one or more transition metal elements. Values of x and y vary according to charge and discharge states of the battery, and are generally in the range of 0.05≦x≦1.10 and 0.05≦y≦1.10.

As a specific example of the foregoing, a lithium-cobalt complex oxide (LiₓCoO₂), a lithium-nickel complex oxide (LiₓNiO₂), a lithium-nickel-cobalt complex oxide (LiₓNi_{1-z}Co_{z}O₂ (z<1)), lithium-manganese complex oxide having a spinel structure (LiMn₂O₄), a lithium iron phosphate compound (Li_{y}FePO₄), a lithium iron manganese phosphate compound (Li_{y}Fe₁₋ᵥMnᵥPO₄ (v<1)) and the like can be cited.

As an electrical conductor, for example, a carbon material such as graphite, carbon black, and Ketjen black can be cited. One thereof may be used singly, or two or more thereof may be used by mixing. In addition to the carbon material, a metal material, a conductive polymer material or the like may be used, as long as such a material has conductivity. As a binder, for example, synthetic rubber such as styrene butadiene rubber, fluorinated rubber, and ethylene propylene diene rubber; or a polymer material such as polyvinylidene fluoride can be cited. One thereof may be used singly, or two or more thereof may be used by mixing.

The anode 22 has an anode current collector 22A having a pair of opposed faces and an anode active material layer 22B provided on the both faces of the anode current collector 22A. In the anode current collector 22A, there is an exposed portion provided with no anode active material layer 22B on one end thereof in the longitudinal direction. The anode terminal 12 is attached to the exposed portion. The anode current collector 22A is made of, for example, a metal foil such as a copper foil, a nickel foil, and a stainless foil.

The anode active material layer 22B contains, as an anode active material, for example, one or more anode materials capable of inserting and extracting lithium. If necessary, the anode active material layer 22B may contain an electrical conductor and a binder. The electrical conductor and the binder similar to those explained for the cathode 21 can be used.

As an anode material capable of inserting and extracting lithium, for example, a carbon material, a metal oxide, a polymer compound and the like can be cited. As the carbon material, for example, graphitizable carbon, non-graphitizable carbon whose face distance of (002) plane is 0.37 nm or more, or graphite whose face distance of (002) plane is 0.340 nm or less can be cited. More specifically, pyrolytic carbons, coke, graphites, glassy carbons, an organic polymer compound fired body, carbon fiber, activated carbon or the like can be cited. Of the foregoing, the coke includes pitch coke, needle coke, petroleum coke and the like. The organic polymer compound fired body is obtained by firing and carbonizing a polymer compound such as a phenol resin and a furan resin at an appropriate temperature. As the metal oxide, an iron oxide, a ruthenium oxide, a molybdenum oxide or the like can be cited. As a polymer compound, polyacetylene, polypyrrole or the like can be cited.

As an anode material capable of inserting and extracting lithium, a material that contains a metal element or a metalloid element capable of forming an alloy with lithium as an element can be cited. Specifically, a simple substance, an alloy, or a compound of the metal element capable of forming an alloy with lithium; a simple substance, an alloy, or a compound of the metalloid element capable of forming an alloy with lithium; or a material that has one or more phases thereof at least in part can be cited.

As the metal element or the metalloid element, for example, tin (Sn), lead (Pb), aluminum, indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) or hafnium (Hf) can be cited. Specially, a metal element or a metalloid element of Group 14 in the long period periodic table is preferable. Silicon or tin is particularly preferable. Silicon and tin have a high ability to insert and extract lithium, and can provide a high energy density.

As an alloy of silicon, for example, an alloy containing at least one selected from the group consisting of tin, nickel, copper, iron, cobalt, manganese, zinc, indium, silver, titanium (Ti), germanium, bismuth, antimony, and chromium (Cr) as a second element other than silicon can be cited. As an alloy of tin, for example, an alloy containing at least one selected from the group consisting of silicon, nickel, copper, iron, cobalt, manganese, zinc, indium, silver, titanium, germanium, bismuth, antimony, and chromium as a second element other than tin can be cited.

As a compound of silicon or a compound of tin, for example, a compound containing oxygen (O) or carbon (C) can be cited. In addition to silicon or tin, the compound may contain the foregoing second element.

One of the cathode 21 and the anode 22 or the both thereof contain, as an absorber, a graphite material whose average face distance of (002) plane of a hexagonal crystal obtained by X-ray diffraction method is from 0.3354 nm to 0.3370 nm, and capable of obtaining the peak belonging to (101) plane of a rhombohedral crystal by X-ray diffraction method. Thereby, impurity such as moisture included in the battery, gas generated due to a side reaction and the like can be absorbed. In addition, the battery characteristics such as a capacity caused by adding the absorber can be prevented from being lowered. The theoretical average face distance of the (002) plane of the hexagonal crystal in graphite is 0.3354 nm.

The graphite material can be obtained by applying physical force, for example, by pulverizing natural graphite with high crystallinity in which the average face distance d002 of the (002) plane of the hexagonal crystal is from 0.3354 nm to 0.3370 nm. It is possible that after the pulverization, the resultant is mechanically molded to obtain a spherical shape. Otherwise, the graphite material can be obtained by using artificial graphite that is fired at about 2900 deg C. and thereby graphitized using coke, tar, pitch or the like as a raw material, and then similarly applying physical force thereto. When the artificial graphite is formed, it is preferable to fire the raw material together with a catalyst, since the graphitization degree can be increased.

When the graphite material is contained in the cathode active material layer 21B, the graphite material functions as an electrical conductor as well. When the graphite material is contained in the anode active material layer 22B, the graphite material functions as an anode active material or an electrical conductor as well. When the graphite material is added to the cathode active material layer 21B, the content thereof in the cathode active material layer 21B is preferably in the range from 0.2 wt % to 10 wt %. When the content is smaller than that range, it is difficult to sufficiently suppress the swollenness. Meanwhile, when the content is larger than that range, the ratio of the cathode active material becomes low, and thus the capacity is lowered. When the graphite material is added to the anode active material layer 22B, the content thereof in the anode active material layer 22B is preferably in the range from 1 wt % to 100 wt %, and more preferably in the range from 2 wt % to 50 wt %. When the content is smaller than that range, it is difficult to sufficiently suppress the swollenness. Meanwhile, when the content is larger than that range, the capacity is lowered.

Further, when the graphite material is used, for the cathode 21 and the anode 22, the intensity of a peak belonging to the (101) plane of the rhombohedral crystal of the graphite obtained by X-ray diffraction method is preferably 1% or more of the intensity of a peak belonging to (101) plane of the hexagonal crystal of the graphite obtained by X-ray diffraction method, and more preferably 60% or less thereof. When the amount of the rhombohedral crystal is small, it is difficult to obtain sufficient absorption ability. Meanwhile, when the amount of the rhombohedral crystal is excessively large, the capacity may be lowered in some cases.

The separator 23 is made of an insulating thin film having large ion transmittance and a given mechanical strength such as a porous film made of a polyolefin synthetic resin such as polypropylene and polyethylene, and a porous film made of an inorganic material such as a ceramics nonwoven. The separator 23 may have a structure in which two or more above-mentioned porous films are layered.

The electrolyte 24 is made of a so-called gelatinous electrolyte in which an electrolytic solution is held in a polymer compound. The electrolyte 24 may be impregnated in the separator 23, or may exist between the separator 23 and the cathode 21, the anode 22.

The electrolytic solution contains, for example, a solvent and an electrolyte salt dissolved in the solvent. As a solvent, for example, a nonaqueous solvent such as a lactone solvent such as γ-butyrolactone, γ-valerolactone, δ-valerolactone, and ε-caprolactone; an ester carbonate solvent such as ethylene carbonate, propylene carbonate, butylene carbonate, vinylene carbonate, dimethyl carbonate, ethyl methyl carbonate, and diethyl carbonate; an ether solvent such as 1,2-dimethoxyethane, 1-ethoxy-2-methoxyethane, 1,2-diethoxyethane, tetrahydrofuran, and 2-methyl tetrahydrofuran; a nitrile solvent such as acetonitrile; a sulfolane solvent; phosphoric acids; a phosphoric ester solvent; and pyrrolidones can be cited. One of the solvents may be used singly, or two or more thereof may be used by mixing.

For the electrolyte salt, any electrolyte salt may be used, as long as such an electrolyte salt is dissolved in the solvent to generate ions. One electrolyte salt may be used singly, or two or more electrolyte salts may be used by mixing. For example, in the case of a lithium salt, lithium hexafluorophosphate (LiPF₆), lithium tetrafluoroborate (LiBF₄), lithium hexafluoroarsenate (LiAsF₆), lithium perchlorate (LiClO₄), lithium trifluoromethanesulfonate (LiCF₃SO₃), imide lithium bis(trifluoromethanesulfonyl) (LiN(SO₂CF₃)₂), methyl lithium tris(trifluoromethanesulfonyl) (LiC(SO₂CF₃)₃), lithium aluminate tetrachloride (LiAlCl₄), lithium hexafluorosilicate (LiSiF₆) or the like can be cited.

As the polymer compound, a fluorinated polymer compound such as polyvinylidene fluoride and a copolymer of vinylidene fluoride and hexafluoropropylene, an ether polymer compound such as polyethylene oxide and a cross-linked body containing polyethylene oxide, polyacrylonitrile or the like can be cited.

For the electrolyte 24, it is possible that the electrolytic solution is not held in the polymer compound, but a liquid electrolyte may be directly used. In this case, the electrolytic solution is impregnated in the separator 23.

The secondary battery can be manufactured, for example, as follows.

First, for example, the cathode 21 is formed by forming the cathode active material layer 21B on the cathode current collector 21A. The cathode active material layer 21B is formed, for example, as follows. A cathode active material powder, an electrical conductor, and a binder are mixed to prepare a cathode mixture, which is dispersed in a solvent such as N-methyl-2-pyrrolidone to obtain paste cathode mixture slurry. Then, the cathode current collector 21A is coated with the cathode mixture slurry, the solvent is dried, and the resultant is compression-molded. Consequently, the cathode active material layer 21B is formed. Further, for example, the anode 22 is formed by forming the anode active material layer 22B on the anode current collector 22A in the same manner as the cathode 21. If necessary, the foregoing graphite material is added to the cathode active material layer 21B, the anode active material layer 22B, or the both thereof. When the graphite material is added to the cathode 21, the graphite may be added as an electrical conductor or may be added together with other electrical conductor. When the graphite material is added to the anode 22, the graphite may be added as an anode active material or an electrical conductor, or may be added together with other anode active material or other electrical conductor.

Next, the cathode terminal 11 is attached to the cathode current collector 21A, and the anode terminal 12 is attached to the anode current collector 22A. Subsequently, the cathode 21 and the anode 22 are layered with the separator 23 in between. The lamination is spirally wound in the longitudinal direction, the protective tape is adhered to the outermost periphery to form a precursor spirally wound electrode body of the spirally wound electrode body 20. After that, the spirally wound electrode body is sandwiched between the package members 30, and the outer peripheral edges except for one side of the package member 30 are thermally fusion bonded, and the electrolyte composition of matter containing a monomer as a raw material of the electrolytic solution and the polymer compound is injected therein. Next, remaining one side of the package member 30 is thermally fusion bonded and hermetically sealed. After that, the monomer is polymerized to form the electrolyte 24. The secondary battery shown in FIGS. 1 and 2 is thereby obtained.

Further, instead of injecting the electrolyte composition of matter into the package member 30 and polymerizing the monomer to form the electrolyte 24, it is possible that after the cathode 21 and the anode 22 are formed, the electrolyte 24 containing the electrolytic solution and the polymer compound is formed thereon, the resultant is spirally wound with the separator 23 in between, and the spirally wound electrode body is inserted in the package member 30.

Further, when the electrolytic solution is used as the electrolyte 24, the spirally wound electrode body is formed as described above, the formed spirally wound electrode body is sandwiched between the package member 30, and then the electrolytic solution is injected therein to hermetically seal the package member 30.

In the secondary battery, when charged, for example, lithium ions are extracted from the cathode 21 and inserted in the anode 22 through the electrolyte 24. Meanwhile, when discharged, for example, the lithium ions are extracted from the anode 22, and inserted in the cathode 21 through the electrolyte 24. Since the foregoing graphite material is contained in the cathode 21 or the anode 22, impurity such as moisture and gas generated due to a side reaction are absorbed, and thus the swollenness is suppressed and the capacity is prevented from being lowered.

As above, according to this embodiment, the cathode 21 or the anode 22 contains a graphite material in which the average face distance d002 of the (002) plane of the hexagonal crystal is from 0.3354 nm to 0.3370 nm, and the peak belonging to the (101) plane of the rhombohedral crystal can be obtained by X-ray diffraction method. Therefore, impurity such as moisture and gas generated due to a side reaction and the like are absorbed, and thus the swollenness can be suppressed and the battery characteristics such as the capacity can be improved.

### EXAMPLES

Further, specific examples of the invention will be described in detail.

### Examples 1-1 to 1-3

The secondary battery using the film package member shown in FIGS. 1 and 2 was fabricated.

First, 0.5 mol of lithium carbonate and 1 mol of cobalt carbonate were mixed. The mixture thereof was fired for 5 hours at 900 deg C. in the air to form lithium cobalt complex oxide (LiCoO₂) as a cathode active material. Next, 85 wt % of the lithium cobalt complex oxide powder, 5 wt % of Ketjen black as an electrical conductor, and 10 wt % of polyvinylidene fluoride as a binder were mixed to prepare a cathode mixture. After that, the cathode mixture slurry was dispersed in N-methyl-2-pyrrolidone as a solvent to form cathode mixture slurry. Subsequently, both faces of the cathode current collector 21A made of an aluminum foil being 20 μm thick were coated with the cathode mixture slurry which was then dried. After that, the resultant was compression-molded to form the cathode active material layer 21B, and thereby the cathode 21 was formed. After that, the cathode terminal 11 was attached to the cathode 21.

Further, 89 wt % of artificial graphite powder, 6 wt % of polyvinylidene fluoride as a binder, 5 wt % of an absorber were mixed to prepare an anode mixture. The anode mixture was dispersed in N-methyl-2-pyrrolidone as a solvent to form anode mixture slurry. The artificial graphite used as the anode active material was obtained by firing and carbonizing a molded material hardened by kneading coke with binder pitch, further adding pitch, and then graphitizing the resultant at 3000 deg C. For the artificial graphite, the average face distance d002 was obtained based on the diffraction line of the (002) plane of the hexagonal crystal in the vicinity of 2θ=26 deg by X-ray diffraction method. The result was 0.3372 nm. As the absorber, spherical natural graphite was used in Example 1-1, and spherical high crystal artificial graphite was used in Examples 1-2 and 1-3. The spherical natural graphite used in Example 1-1 was obtained by pulverizing high-purity natural graphite, removing impurity, and then mechanically molding the resultant to obtain a spherical shape. The spherical high crystal artificial graphite used in Examples 1-2 and 1-3 was obtained by pulverizing the high crystallized artificial graphite with the graphitization degree improved by firing coke as a raw material together with a catalyst in graphitization, and then mechanically molding the resultant to obtain a spherical shape.

For the spherical natural graphite used in Example 1-1, and the spherical high crystal artificial graphite used in Examples 1-2 and 1-3, carbon was respectively identified by X-ray diffraction method. Then, the average face distance d002 was respectively obtained based on the diffraction line of the (002) plane of the hexagonal crystal in the vicinity of 2θ=26 deg. In the result, the average face distance d002 of the spherical natural graphite used in Example 1-1 was 0.3364 nm. The average face distance d002 of the spherical high crystal artificial graphite used in Example 1-2 was 0.3368 nm. The average face distance d002 of the spherical high crystal artificial graphite used in Example 1-3 was 0.3359 nm. The results thereof are shown in Table 1.

Next, both faces of the anode current collector 22A made of a copper foil being 15 μm thick were coated with the anode mixture slurry which was then dried. After that, the resultant was compression-molded to form the anode active material layer 22B, and thereby the anode 22 was formed. For the formed anode 22 of Examples 1-1 to 1-3, the peak intensity ratio of the (101) plane of the rhombohedral crystal to the (101) plane of the hexagonal crystal was obtained, based on the diffraction line of the (101) plane of the rhombohedral crystal of the graphite in the vicinity of 2θ=43.3 deg and the diffraction line of the (101) plane of the hexagonal crystal of the graphite in the vicinity of 2θ=44.5 deg respectively with the use of X-ray diffraction method. In the result, the peak intensity ratio of Example 1-1 was 0.02, that is, the intensity of a peak of the (101) plane of the rhombohedral crystal was 2% of the intensity of a peak of the (101) plane of the hexagonal crystal. The intensity of a peak of Example 1-2 was 0.01, that is, the intensity of a peak of the (101) plane of the rhombohedral crystal was 1% of the intensity of a peak of the (101) plane of the hexagonal crystal. The peak intensity ratio of Example 1-3 was 0.03, that is, the intensity of a peak of the (101) plane of the rhombohedral crystal was 3% of the intensity of a peak of the (101) plane of the hexagonal crystal. The results are shown in Table 1.

Subsequently, the anode terminal 12 was attached to the anode 22. After that, the formed cathode 21 and the formed anode 22 were layered with the separator 23 made of a microporous polyethylene film being 25 μm thick in between and contacted. The lamination was spirally wound in the longitudinal direction to form a spirally wound electrode body. Next, the formed spirally wound electrode body was inserted between the package members 30, and the outer peripheral edges except for one side of the package member 30 were thermally fusion bonded. For the package member 30, a moisture resistance aluminum laminated film in which a nylon film being 25 μm, an aluminum foil being 40 μm, and a polypropylene film being 30 μm were layered sequentially from the outermost layer was used.

Subsequently, an electrolytic solution was prepared by dissolving lithium phosphate hexafluoride at a concentration of 1 mol/l in a mixed solvent of ethylene carbonate and diethyl carbonate at a weight ratio of ethylene carbonate:diethyl carbonate=3:7. After that, 5 parts by weight of a polymer compound and 0.1 parts by weight of t-butyl peroxy neodecanoate as a polymerization initiator were mixed to 100 parts by weight of the electrolytic solution, and an electrolyte composition of matter was formed. Then, for the polymer compound, a mixture of trimethylol propane triacrylate shown in Chemical formula 1 and neopentyl glycol diacrylate shown in Chemical formula 2 at a weight ratio of trimethylol propane triacrylate:neopentyl glycol diacrylate=3:7 was used.

CH₃CH₂C(CH₂OOCCH═CH₂)₃ (Chemical Formula 1)

CH₂═CHCOOCH₂C(CH₃)₂CH₂OOCCH═CH₂ (Chemical formula 2)

Next, the electrolyte composition of matter was injected in the package member 30. The remaining one side of the package member 30 was thermally fusion bonded. The resultant was sandwiched between glass plates, heated for 15 minutes at 80 deg C. to polymerize the polymer compound. Thereby, the gelatinous electrolyte 24 was formed and the secondary battery shown in FIGS. 1 and 2 was obtained.

Further, as Comparative example 1-1 relative to Examples 1-1 to 1-3, a secondary battery was formed in the same manner as in Examples 1-1 to 1-3, except that the absorber was not added when the anode active material layer was formed, and the ratio of the artificial graphite was 94 wt %. Further, as Comparative examples 1-2 to 1-9, secondary batteries were fabricated in the same manner as in Examples 1-1 to 1-3, except that the type of absorber added to the anode active material layer was changed as shown in Table 1. Specifically, in Comparative example 1-2, an activated carbon in which carbon fiber obtained by firing rayon was activated in carbon dioxide gas was used. In Comparative example 1-3, coke was used. In Comparative example 1-4, pyrolytic carbon obtained on a fluid bed by pyrolyzing propane was used. In Comparative example 1-5, hard carbon obtained by firing a phenol resin was used. In Comparative example 1-6, mesocarbon microbeads obtained by graphitizing mesophase sphere was used. In Comparative example 1-7, vapor grown carbon fiber that was vapor grown on a catalyst at 1100 deg C. in the hydrocarbon gas atmosphere was used. In Comparative example 1-8, natural graphite powder obtained by pulverizing high-purity natural graphite and removing impurity was used. In Comparative example 1-9, high crystallized artificial graphite powder with the graphitization degree improved by firing coke as a raw material together with an catalyst in graphitization was used.

For the absorber used in Comparative examples 1-2 to 1-9, the average face distance d002 was obtained based on the diffraction line of the (002) plane of the hexagonal crystal in the same manner as in Examples 1-1 to 1-3. Further, for the anodes of Comparative examples 1-1 to 1-9, the peak intensity ratio of the (101) plane of the rhombohedral crystal to the (101) plane of the hexagonal crystal of the graphite was respectively obtained. These results are shown in Table 1 together. “-” shown in Table 1 means that measurement was incapable. Further, the physical value of the artificial graphite used as the anode active material is shown in the column of Comparative example 1-1.

For the fabricated secondary batteries of Examples 1-1 to 1-3 and Comparative examples 1-1 to 1-9, after constant current and constant voltage charge of 100 mA at 23 deg C. was performed for 15 hours up to 4.2 V, constant current discharge of 100 mA at 23 deg C. was performed until the final voltage of 2.5 V, and thereby the initial discharge capacity was obtained.

Further, for each secondary battery whose initial discharge capacity was obtained under the foregoing conditions, after constant current and constant voltage charge of 500 mA at 23 deg C. was performed for 2 hours up to 4.2 V, constant current discharge of 250 mA at −20 deg C. was performed until the final voltage of 3.0 V, and thereby the discharge capacity at low temperatures was measured. Based on the obtained discharge capacity at low temperatures and the initial discharge capacity at 23 deg C., as the low temperature characteristics, the discharge capacity retention ratio at low temperatures was calculated based on (discharge capacity at low temperatures/initial discharge capacity)×100.

Further, for each secondary battery for which initial charge and discharge was separately performed under the foregoing conditions, after the thickness of the battery was measured, charge was again performed for 3 hours up to 4.31 V, stored for 1 month in the constant temperature bath at 60 deg C., and the thickness of the battery after storage was measured. Then, the value obtained by subtracting the thickness of the battery before storage from the thickness of the battery after storage was obtained as swollenness after storage.

In addition, each secondary battery for which the initial charge and discharge was separately performed under the foregoing conditions was disassembled, 20 mg of the anode active material layer 22B was cut off, and such a cut-off portion was enclosed in a hermetically sealed bottle in the argon box, carbon dioxide reference gas was infused by a syringe, and then the residual ratio of the carbon dioxide after storage for 4 hours at 90 deg C. was examined. For the measurement, a gas chromatography/weight spectroscope was used. 0.2 ml of gas in the hermetically sealed glass was qualified and quantified. The results are shown in Table 1.

TABLE 1

| | | | Rhombohedral | | | | |
|---|---|---|---|---|---|---|---|
| | | | crystal/hexagonal | | | | |
| | | | crystal | Co₂ | Initial | Low | Swollenness |
| | | | (101) plane | residual | discharge | temperature | after |
| | | d002 | peak intensity | ratio | capacity | characteristics | storage |
| | Absorber | (nm) | ratio | (%) | (mAh) | (%) | (mm) |
| Example 1-1 | Spherical natural | 0.3364 | 0.02 | 39 | 772 | 66 | 0.3 |
| | graphite | | | | | | |
| Example 1-2 | Spherical high | 0.3368 | 0.01 | 38 | 774 | 67 | 0.2 |
| | crystal artificial | | | | | | |
| | graphite | | | | | | |
| Example 1-3 | Spherical high | 0.3359 | 0.03 | 35 | 776 | 68 | 0.2 |
| | crystal artificial | | | | | | |
| | graphite | | | | | | |
| Comparative | None | 0.3372 | — | 92 | 759 | 59 | 3.1 |
| example 1-1 | (Artificial | | | | | | |
| | graphite) | | | | | | |
| Comparative | Activated carbon | — | — | 66 | 753 | 60 | 0.5 |
| example 1-2 | fiber | | | | | | |
| Comparative | Coke | 0.340 | — | 88 | 735 | 42 | 3.2 |
| example 1-3 | | | | | | | |
| Comparative | Pyrolytic carbon | 0.343 | — | 93 | 718 | 37 | 3.4 |
| example 1-4 | | | | | | | |
| Comparative | Hard carbon | — | — | 72 | 747 | 31 | 2.7 |
| example 1-5 | | | | | | | |
| Comparative | Mesocarbon | 0.3373 | — | 90 | 760 | 59 | 3.5 |
| example 1-6 | microbead | | | | | | |
| Comparative | Vapor grown | 0.3362 | — | 92 | 756 | 58 | 3.1 |
| example 1-7 | carbon fiber | | | | | | |
| Comparative | Natural graphite | 0.3360 | — | 65 | 767 | 61 | 1.2 |
| example 1-8 | | | | | | | |
| Comparative | High crystallized | 0.3365 | — | 68 | 768 | 65 | 1.3 |
| example 1-9 | artificial graphite | | | | | | |

As shown in Table 1, according to Examples 1-1 to 1-3, compared to Comparative example 1-1 in which the absorber was not added, the swollenness after storage and the residual ratio of carbon dioxide became smaller, and the initial discharge capacity and the low temperature characteristics were improved. Meanwhile, in Comparative example 1-2 using the activated carbon fiber, though the swollenness and the residual ratio of carbon dioxide became smaller compared to those of Comparative example 1-1, the decreased level was not large compared to those of Examples 1-1 to 1-3, and the initial discharge capacity was lowered. In Comparative examples 1-3 to 1-7, swollenness was not able to be suppressed, and the initial discharge capacity and the low temperature characteristics were lowered down to the same level as or lower than that of Comparative example 1-1. Further, in Comparative examples 1-8 and 1-9 using the natural graphite or the high crystallized artificial graphite in which the average face distance d002 of the (002) plane of the hexagonal crystal was from 0.3354 nm to 0.3370 nm, the swollenness and the residual ratio of carbon dioxide could be smaller than those of Comparative example 1-1, and the initial discharge capacity and the low temperature characteristics could be improved. However, in comparative examples 1-8 and 1-9, the swollenness could not be suppressed as much as in Comparative example 1-2 using the activated carbon fiber.

That is, it was found that when the graphite material in which the average face distance d002 of the (002) plane of the hexagonal crystal was from 0.3354 nm to 0.3370 nm, and the peak belonging to the (101) plane of the rhombohedral crystal was obtained was used, the swollenness of the battery could be suppressed, and the battery characteristics such as the capacity and the low temperature characteristics could be improved.

### Examples 2-1 to 2-4

Secondary batteries were fabricated in the same manner as in Example 1-1, except that the ratio and the physical value of the spherical natural graphite in the anode active material layer 22B were changed. In Example 2-1, 93.06 wt % of granular artificial graphite, 6 wt % of polyvinylidene fluoride, and 0.94 wt % of the spherical natural graphite were used. In Example 2-2, 47 wt % of granular artificial graphite, 6 wt % of polyvinylidene fluoride, and 47 wt % of the spherical natural graphite were used. In Examples 2-3 and 2-4, 0 wt % of granular artificial graphite, 6 wt % of polyvinylidene fluoride, and 94 wt % of the spherical natural graphite were used.

For the spherical natural graphite used in Examples 2-1 to 2-4, in the same manner as in Example 1-1, the average face distance d002 was obtained from the diffraction line of the (002) plane of the hexagonal crystal. Further, for the anode 22 of Examples 2-1 to 2-4, in the same manner as in Example 1-1, the peak intensity ratio of the (101) plane of the rhombohedral crystal to the (101) plane of the hexagonal crystal was obtained, respectively. Further, for the fabricated secondary batteries of Examples 2-1 to 2-4, in the same manner as in Example 1-1, the initial discharge capacity, the low temperature characteristics, the swollenness after storage, and the residual ratio of carbon dioxide were measured. The results thereof are shown in Table 2 together with the results of Example 1-1 and Comparative example 1-1.

TABLE 2

| | | | | Rhombohedral | | | | |
|---|---|---|---|---|---|---|---|---|
| | | | | crystal/hexagonal | | | | |
| | | | | crystal | Co₂ | Initial | Low | Swollenness |
| | | Addition | | (101) plane | residual | discharge | temperature | after |
| | | amount | d002 | peak intensity | ratio | capacity | characteristics | storage |
| | Absorber | (wt %) | (nm) | ratio | (%) | (mAh) | (%) | (mm) |
| Example 2-1 | Spherical | 0.94 | 0.3364 | 0.01 | 50 | 773 | 67 | 0.4 |
| Example 1-1 | natural | 5 | 0.3364 | 0.02 | 39 | 772 | 66 | 0.3 |
| Example 2-2 | graphite | 47 | 0.3364 | 0.23 | 12 | 768 | 62 | 0.1 |
| Example 2-3 | | 94 | 0.3363 | 0.58 | 0 | 761 | 58 | 0 |
| Example 2-4 | | 94 | 0.3362 | 0.67 | 0 | 751 | 39 | 0 |
| Comparative | None | — | | — | 92 | 759 | 59 | 3.1 |
| example 1-1 | | | | | | | | |

As shown in Table 2, according to Examples 2-1 to 2-4, similarly to Example 1-1, compared to Comparative example 1-1 in which the spherical natural graphite was not added, the swollenness and the residual ratio of carbon dioxide could be smaller. However, there was a tendency that when the addition amount of the spherical natural graphite was increased, the swollenness and the residual ratio of the carbon dioxide were lowered, but the initial discharge capacity and the low temperature characteristics were lowered. Further, even when the peak intensity ratio of the (101) plane of the rhombohedral crystal to the (101) plane of the hexagonal crystal of the graphite in the anode 22 was increased, similar tendency was observed.

That is, it was found that the content of the absorber in the anode active material layer 22B was preferably in the range from 1 wt % to 100 wt %, and more preferably in the range from 2 wt % to 50 wt %. Further, it was found that for the anode 22, the peak belonging to the (101) plane of the rhombohedral crystal of the graphite obtained by X-ray diffraction method was preferably 1% or more of the intensity of a peak belonging to the (101) plane of the hexagonal crystal of the graphite obtained by X-ray diffraction method, and more preferably 60% or less thereof.

### Examples 3-1 to 3-6

Secondary batteries were fabricated in the same manner as in Examples 1-1 and 1-2, except that the absorber was added to the cathode active material layer 21B instead of the anode active material layer 22B. In Examples 3-1 and 3-2, when the cathode active material layer 21B was formed, 5 wt % of spherical natural graphite or spherical high crystallized artificial graphite was added as an electrical conductor, and when the anode active material layer 22B was formed, the absorber was not added, and the ratio of the granular artificial graphite was 94 wt %. In Examples 3-3 to 3-6, when the cathode active material layer 21B was formed, spherical natural graphite was used as an electrical conductor and the content thereof in the cathode active material layer 21B was changed in the range from 0.1 wt % to 12 wt %, and when the anode active material layer 22B was formed, the absorber was not added and the ratio of the granular artificial graphite was 94 wt %. The spherical natural graphite and the spherical high crystallized artificial graphite used in Examples 3-1 to 3-6 were identical with those used in Examples 1-1 and 1-2.

For the fabricated secondary batteries of Examples 3-1 to 3-6, in the same manner as in Examples 1-1 and 1-2, the initial discharge capacity, the low temperature characteristics, the swollenness after storage, and the residual ratio of carbon dioxide were measured. The results thereof are shown in Tables 3 and 4 together with the results of Examples 1-1, 1-2 and Comparative example 1-1.

TABLE 3

| | | | | Co₂ | Initial | Low | |
|---|---|---|---|---|---|---|---|
| | | | Addition | residual | discharge | temperature | Swollenness |
| | | Addition | amount | ratio | capacity | characteristics | after storage |
| | Absorber | place | (wt %) | (%) | (mAh) | (%) | (mm) |
| Example 1-1 | Spherical | Anode | 5 | 39 | 772 | 66 | 0.3 |
| Example 3-1 | natural | Cathode | 5 | 39 | 765 | 67 | 0.3 |
| | graphite | | | | | | |
| Example 1-2 | Spherical | Anode | 5 | 38 | 774 | 67 | 0.2 |
| Example 3-2 | high | Cathode | 5 | 39 | 763 | 67 | 0.2 |
| | crystallized | | | | | | |
| | artificial | | | | | | |
| | graphite | | | | | | |
| Comparative | None | — | — | 92 | 759 | 59 | 3.1 |
| example 1-1 | | | | | | | |

TABLE 4

| | | | | Co₂ | Initial | Low | |
|---|---|---|---|---|---|---|---|
| | | | Addition | residual | discharge | temperature | Swollenness |
| | | Addition | amount | ratio | capacity | characteristics | after storage |
| | Absorber | place | (wt %) | (%) | (mAh) | (%) | (mm) |
| Example 3-3 | Spherical | Cathode | 0.1 | 81 | 775 | 67 | 2.2 |
| Example 3-4 | natural | | 0.2 | 75 | 770 | 67 | 1.4 |
| Example 3-1 | graphite | | 5 | 39 | 765 | 67 | 0.3 |
| Example 3-5 | | | 10 | 28 | 705 | 69 | 0.1 |
| Example 3-6 | | | 12 | 21 | 620 | 72 | 0 |

As shown in Table 3, according to Examples 3-1 and 3-2, similarly to Examples 1-1 and 1-2, compared to Comparative example 1-1 in which the absorber was not added, the swollenness and the residual ratio of carbon dioxide could be smaller, and the initial discharge capacity and the low temperature characteristics were improved. That is, it was found that similar effects could be obtained regardless of whether the absorber was added to the cathode 21 or to the anode 22.

Further, as shown in Table 4, when the addition amount of the absorber was increased, there was a tendency that the swollenness and the residual ratio of carbon dioxide were decreased and the low temperature characteristics were improved, but the initial discharge capacity was decreased. That is, it was found that the content of the absorber in the cathode active material layer 21B was preferably in the range from 0.2 wt % to 10 wt %.

### Example 4-1

A secondary battery was fabricated in the same manner as in Example 1-2, except that silicon powder was used instead of the artificial graphite as the anode active material. Spherical high crystallized artificial graphite used as the absorber was identical with that in Example 1-2. As Comparative example 4-1 relative to Example 4-1, a secondary battery was fabricated in the same manner as in Example 4-1, except that 5 wt % of the artificial graphite was added as the electrical conductor instead of the absorber.

For the fabricated secondary batteries of Example 4-1 and Comparative example 4-1, in the same manner as in Example 1-2, the initial discharge capacity, the low temperature characteristics, the swollenness after storage, and the residual ratio of carbon dioxide were measured. The results thereof are shown in Table 5 together with the results of Example 1-2.

TABLE 5

| | | | | Co₂ | Initial | | |
|---|---|---|---|---|---|---|---|
| | | Addition | Anode | residual | discharge | Low temperature | Swollenness |
| | | amount | active | ratio | capacity | characteristics | after storage |
| | Absorber | (wt %) | material | (%) | (mAh) | (%) | (mm) |
| Example 1-2 | Spherical | 5 | Graphite | 38 | 774 | 67 | 0.2 |
| Example 4-1 | high | 5 | Silicon | 41 | 1012 | 67 | 0.4 |
| | crystallized | | | | | | |
| | artificial | | | | | | |
| | graphite | | | | | | |
| Comparative | — | — | Silicon | 98 | 1013 | 68 | 4.8 |
| example 4-1 | | | | | | | |

As shown in Table 5, according to Example 4-1, similarly to Example 1-2, compared to Comparative example 4-1, the swollenness and the residual ratio of carbon dioxide could be largely decreased. That is, it was found that similar effects could be obtained even when other anode active material was used.

The invention has been described with reference to the embodiments and the examples. However, the invention is not limited to the embodiments and the examples, and various modifications may be made. For example, in the foregoing embodiments and the foregoing examples, the descriptions have been given of the case using the electrolytic solution or the gelatinous electrolyte in which the electrolytic solution is held in the polymer compound as an electrolyte. However, other electrolyte may be used. As other electrolyte, for example, an organic solid electrolyte in which an electrolyte salt is dissolved or diffused in a polymer compound having ion conductivity, an inorganic solid electrolyte containing an ion conductive inorganic compound such as ion conductive ceramics, ion conductive glass, and ionic crystal, or a mixture of such an electrolyte and an electrolytic solution can be cited.

Further, in the foregoing embodiment and the foregoing example, the description has been given of the case in which the spirally wound electrode body in which the cathode 21 and the anode 22 were spirally wound is included inside the package member 30. However, one layer or a plurality of layers of the cathode 21 and the anode 22 may be layered.

Further, in the foregoing embodiment and the foregoing examples, the descriptions have been given of the case using lithium as the electrode reactant. However, the invention can be also applied to the case using other alkali metal such as sodium (Na) and potassium (K), an alkali earth metal such as magnesium and calcium (Ca), or other light metal such as aluminum. In addition, the invention can be applied not only to the secondary batteries but also other battery such as primary batteries.

1. A battery comprising:
a cathode, an anode, an electrolyte and a film package member containing the cathode, the anode and the electrolyte therein,
wherein at least one of the cathode and the anode is an electrode containing a graphite material in which an average face distance d002 of (002) planes of a hexagonal crystal obtained by X-ray diffraction method is from 0.3354 nm to 0.3370 nm, and a peak belonging to a (101) plane of a rhombohedral crystal can be obtained by the X-ray diffraction method.

2. The battery according to claim 1, wherein in the electrode, the intensity of a peak belonging to the (101) plane of the rhombohedral crystal of the graphite obtained by the X-ray diffraction method is 1% or more of the intensity of a peak belonging to a (101) plane of the hexagonal crystal of the graphite.

3. The battery according to claim 1, wherein the package member is made of an aluminum laminated film.
